(19) United States
(12) Patent Application Publication
(10) Pub. No.: US 2002/0095436 A1
(43) Pub. Date: Jul. 18, 2002

(54) System for providing information associated with software package and supporting test therefor

(76) Inventor: Jae-II Lee, Seoul (KR)

Correspondence Address: Robert E. Bushnell, Suite 300, 1522 K Street, N.W., Washington, DC, 20005, US

(21) Appl. No.: 09/973,700

(22) Filed: Oct. 11, 2001

(30) Foreign Application Priority Data
Jan. 12, 2001 (KR) 2001-1839

(51) Int. Cl. G06F 12/00

(52) U.S. Cl. 707/203

(57) ABSTRACT

A system for improving the efficiency and reliability of software package development and source version management, and the efficiency of software package creation, and for rapidly searching information regarding software packages. In this system, a user is provided with information associated with the software package creation from a server through a client using the Web. The creation of test data by the user is supported by the server.

### CLAIM OF PRIORITY

This application claims priority to an application entitled SYSTEM FOR OFFERING SOFTWARE PACKAGE MAKE INFORMATION AND SUPPORTING TEST A SYSTEM UTILIZING THE SOFTWARE PACKAGE, filed in the Korean Industrial Property Office on Jan. 12, 2001 and assigned Serial No. 2001-1839, the contents of which are hereby incorporated by reference.

### BACKGROUND OF THE INVENTION

1. Technical Field

The present invention relates in general to the creation of software packages and, more particularly, to a system for providing information associated with a software package and a supporting test therefor.

2. Description of the Related Art

At the present, it is necessary to create respective software packages for the development of private branch exchanges and similar systems. A large amount of information associated with such a software package creation is provided by a software integration support system (SWISS), which is a software integration support tool. The SWISS is constructed on a self-developed X-Window Motif graphic user interface (GUI) of UNIX, such as SABLIME, which is a configuration management tool commercially available from Lucent Technologies. The use of the SWISS enables a software package to be created by developing and compiling private branch exchange software on a UNIX host.

Provided on UNIX are package creation specifications, a list of package modification requests (MRs), software block configuration information, test data, creation support/MR information, and so forth. The test data may be, for example, processor loading data (PLD) and man machine subsystem data (MMSDATA) for testing systems employing software packages.

However, since the above information is provided on UNIX via the X-terminal GUI based on the SWISS, a user (such as a software package developer or consumer) must gain direct access to a host equipped with a software integration support tool, such as the SWISS, in order to search the host for information associated with creation of the software package, or to create test data on the host. As a result, unless a personal computer (PC) user purchases and installs X-Window emulator software on the PC, he or she will not be able to use the SWISS. In this regard, in order to acquire information about a software package for the purpose of testing, in a system model room, of an exchange system, the user has to purchase the X-Window emulator software and install it on his or her PC, and he or she must also purchase separate X-terminal dedicated equipment and install it on his or her PC.

There is another problem in that a variety of complex environments must be set up for application of the SWISS to other similar system development projects. Moreover, there is a blind spot in the capability of the X-Window Motif GUI of UNIX in that it has difficulty in supporting 2-byte code-based characters (for example, Korean characters, Chinese characters, Japanese characters, etc).

As mentioned above, conventionally, the use of a Motif library on UNIX forces the PC user to purchase a high-cost X-terminal emulator, and makes it very hard to apply the SWISS to various similar system development projects. Accordingly, the use of the Motif library on UNIX is limited when it comes to improving efficiency and reliability of software package development and source version management. This results in a degradation in the efficiency of software package creation, and in difficulty in searching for information regarding software packages.

### SUMMARY OF THE INVENTION

The present invention has been made in view of the above problems, and thus it is an object of the present invention to provide a system which is capable of improving the efficiency and reliability of software package development and source version management.

It is another object of the present invention to provide a system which is capable of improving the efficiency of software package creation.

It is yet another object of the present invention to provide a system which is capable of rapidly searching for information regarding software packages.

In accordance with one aspect of the present invention, the above and other objects can be accomplished by the provision of a system for providing information associated with the creation of a software package, the system comprising: a server including a database having the software package creation associated information stored therein, and an application which, when a client requests a server on the Web (World Wide Web: WWW) to output the software package creation associated information, gains access to the database to extract the software package creation associated information therefrom, and then sends the extracted information to the client; and a Web client tool set-up associated with the client for accessing the server, the client being responsive to a software package creation associated information request from a user for downloading the software package creation associated information from the server over the Web, and for providing the downloaded information to the user.

In accordance with another aspect of the present invention, there is provided a system for supporting creation of test data for testing a system employing a software package, the system comprising: a server including a test data storage unit for storing information associated with the test data creation and the test data, and an application which, when a client requests a server on is the Web to create the test data, executes an associated task to create the test data, and stores the created test data in a test data storage unit; and a Web client tool set-up associated with the client for accessing to the server, the client being responsive to a test data creation request from a user for sending a test data creation request message to the server over the Web.

### BRIEF DESCRIPTION OF THE DRAWINGS

A more complete appreciation of the invention, and many of the attendant advantages thereof, will be readily apparent as the same becomes better understood by reference to the following detailed description when considered in conjunction with the accompanying drawings, in which like reference numerals indicate the same or similar components, and wherein:

FIG. 1 is a block diagram showing the construction of a system in accordance with the present invention;

FIG. 2 is a view illustrating the operation of the system of FIG. 1;

FIG. 3 is a flowchart illustrating the package creation specification output process shown in FIG. 2;

FIG. 4 is a flowchart illustrating the software block configuration registration process shown in FIG. 2;

FIG. 5 is a flowchart illustrating the software block configuration deletion process shown in FIG. 2;

FIG. 6 is a flowchart illustrating the software block configuration list output process shown in FIG. 2; and

FIG. 7 is a flowchart illustrating the test data creation process shown in FIG. 2.

### DETAILED DESCRIPTION OF THE PREFERRED EMBODIMENTS

Preferred embodiments of the present invention will now be described in detail with reference to the annexed drawings. In the following description, a detailed description of known functions and configurations incorporated herein will be omitted when it will make the subject matter of the present invention unclear.

This inventor has examined a text menu-based method as an approach to the above-mentioned problems. However, the inventor has considered that a Web-based method, rather than the text menu-based method, will be able to support developers with patterns which are similar to the existing UNIX X-terminal GUI, and is less difficult to use in that it has user-friendly functions. Because all users currently use PCs with Web client tools, such as MS-IE, Netscape and the like, set up therein, they can also use the SWISS without the necessity of installing separate programs in the PCs. The blind spot of the X-terminal, or the difficulty in supporting 2-byte code-based characters (for example, Korean characters, Chinese characters, Japanese characters, etc.), can also be solved on the Web by using a true font by Microsoft (MS).

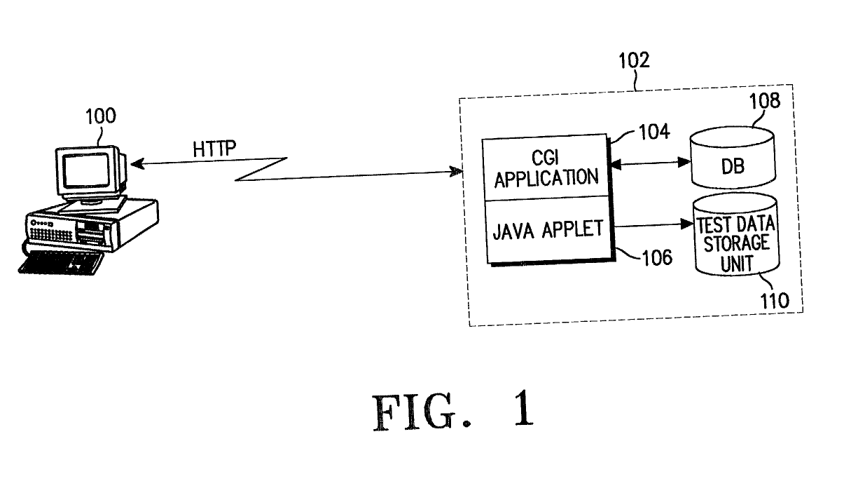

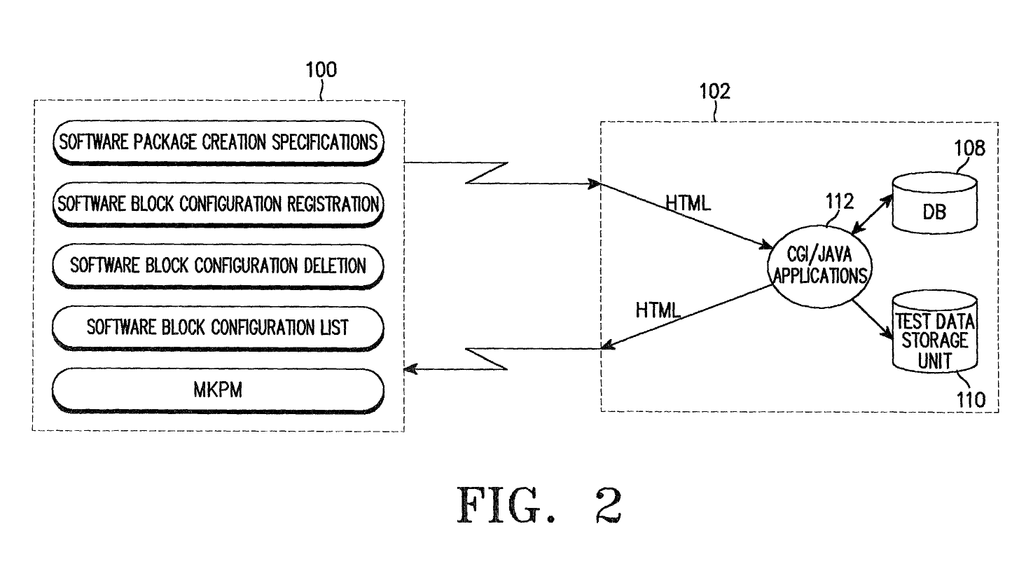

FIG. 1 is a block diagram showing the construction of a Web-based system according to a preferred embodiment of the present invention, and FIG. 2 is a view illustrating the operation of the system of FIG. 1. As shown in FIG. 1, the present system comprises a client 100 and server 102 interconnected via a hypertext transfer protocol (HTTP). The server 102 includes a common gateway interface (CGI) application 104 and a JAVA application 106 which access a database (DB) 108 and combine associated information therefrom. The client 100 includes a Web client tool accessible to the server 102. The client 100 sends information entered on a Web page by a user to the server 102 via a user interface, and provides information downloaded from the server 102 to the user via the user interface. Displayed on a screen of the client is an entry menu having listed therein (as shown in FIG. 2) a plurality of items calling for the output of typical information associated with package creation. The items include software package creation specifications, software block configuration registration, software block configuration deletion, a software block configuration list, and test data creation or MKPM (Make PLD and MMSDATA). The software package creation specifications and software block configuration list are typically provided to consumers purchasing and using software packages, while the software block configuration registration, software block configuration deletion and MKPM items are typically provided only to developers. The software block configuration list is a list of configurations of a corresponding software package in generic form. Each of the generic forms may be, for example, a project of the corresponding software package. The server 102 creates the entry menu in hypertext markup language (HTML) and provides it to the client 100. Further, the server 102 extracts information, associated with user entry information sent from the client 100, from the DB 108 using CGI/JAVA applications 112, or the CGI application 104 and JAVA applet 106, and sends the extracted information to the client 100.

The DB 108 is partitioned into two regions: one managing package creation specifications, a list of MRs, and the contents of the MRs; and the other storing software block configurations. The DB 108 is already constructed on the existing UNIX X-terminal tool. On the basis of a CGI, such as a perl or shell, the server 102 searches the already constructed DB 108 for information desired by the client 100 so as to extract the desired information from the DB 108, registers the extracted information, converts the registered information into HTML information, and sends the converted HTML information to the client 100. A test data storage unit 110 is also provided to store a component and IROF registered according to the MKPM function based on the JAVA applet 106, and a file created according to the MKPM function.

In order to realize the software package creation specifications output function, the software block configuration registration and deletion functions, and the software block configuration list output function, the system described above with reference to FIGS. 1 and 2 must have a function implemented to search the contents registered in the DB 108 for desired information so as to extract the desired information from the DB 108, converts the extracted information into HTML information, and sends the converted HTML information to the client 100. In the present embodiment, such a function is implemented on the basis of a CGII that is currently most widely used for Web construction. It should be noted herein that the CGII is implemented in the form of the perl and shell, which is easy to maintain and has excellent text processability, although it may be implemented in various languages.

On the other hand, for implementation of the MKPM function, this inventor has attempted to use a JAVA foundation class (JFC) contained in JAVA JDK 2.x. But, MS-IE and Netscape, which are client tools published until now, support nothing but JAVA JDK 1.x series. For this reason, the present invention employs AWT, which is a basic tool supporting the JAVA GUI. Two methods have been proposed to enable the user to register a file using the client 100. In the first method, the user can register a file by downloading it from his or her home directory on UNIX to a PC for the client 100 according to a file transfer protocol (FTP). In the second method, the user can register a file by connecting his or her UNIX home directory to a network drive on the PC using a virtual disk connection tool, such as SAMBA, and gaining direct access to a UNIX disk. For connection of the UNIX disk to the PC network drive using SAMBA, in a UNIX system used as a developing host, a developer's user identification (ID) must first be registered and SAMBA must be installed. After registration is completed, the user runs Windows Explorer on his or her PC and selects “menu tool® network drive connection” in Explorer. Then, a sub-window pops up, and the sub-window has a path column to be filled in with “\\hostname\user-id”. For example, if the host name is “maui” and the user ID is “jilee”, the user will enter “\\maui\jilee” in the path column. Upon completion of the entry, the user clicks “OK” and enters a log-in password of the UNIX host in response to a password entry request, resulting in the network drive connection being completed.

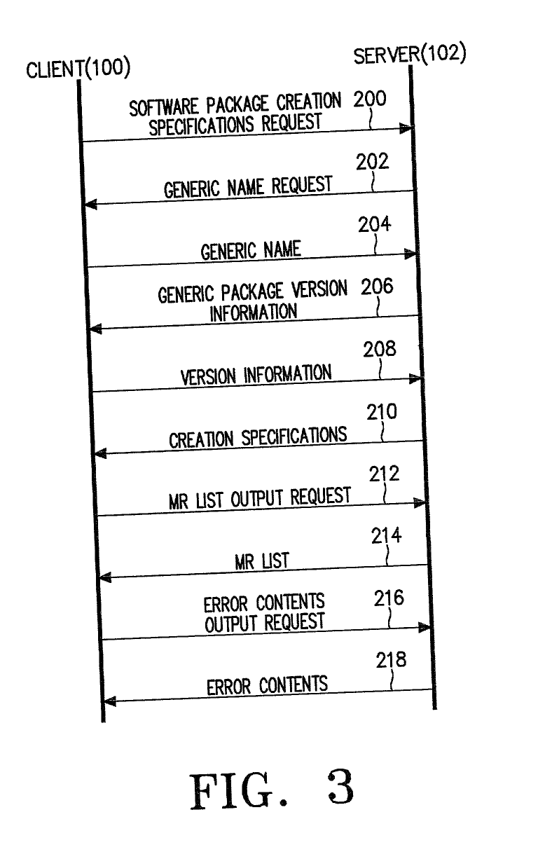

A detailed description will hereinafter be given of the operation of the system with the above-stated construction in accordance with the preferred embodiment of the present invention with reference to FIGS. 3 to 7, which are flowcharts illustrating respective processes of the menu items of the system, that is, package creation specifications output, software block configuration registration, software block configuration deletion, software block configuration list output, and test data creation.

FIG. 3 is a flowchart illustrating the package creation specifications output process shown in FIG. 2, and includes steps 200 to 218 performed between the client 100 and the server 102. First, upon completing the creation of a software package, a package creator stores package creation specifications, a list of MRs, the contents of the MRs, compile error information, and so forth in the DB 108. If the user selects the package creation specifications output menu item in the client 100 under such a condition, then the client 100 sends a package creation specifications request message to the server 102 at step 200. In response to the specifications request message sent from the client 100, the server 102 sends a generic name request HTML message to the client 100 at step 202, requesting the client 100 to select a desired generic name or project name. Upon receiving the HTML message sent from the server 102, the user selects a desired generic name using the client 100, which in turn sends the selected generic name as generic information to the server 102 at step 204. At step 206, the server 102 inputs the generic information from the client 100, and runs the CGI application 104 to search the DB 108 for package creation specifications associated with the inputted generic information. The CGI application 104 is run to extract, from the DB 108, information about a package version of a generic corresponding to the inputted generic information, to convert the extracted generic package version information into HTML version information, and to send the converted HTML version information to the user of the client 100. The user of the client 100 selects a desired version with reference to the version information sent from the server 102. Then, the client 100 sends information regarding the version selected by the user to the CGI application 104 of the server 102 at step 208, and the CGI application 104 searches the DB 108 for package creation specifications associated with the version information sent from the client 100 so as to extract the associated package creation specifications from the DB 108, performs an HTML conversion for the extracted package creation specifications, and sends the resulting package creation specifications to the user of the client 100, at step 210. The user of the client 100 can see MR contents in the package creation specifications sent from the server 102 by selecting a part of the sent specifications where the number of MRs is displayed. The user of the client 100 can also see the contents of errors generated during package creation by selecting an error block part of the sent specifications. If the user selects the MRs number part, then the client 100 sends an MR list output request message to the server 102 at step 212. In response to the output request message sent from the client 100, the server 102 searches the DB 108 for an MR list, and sends the searched MR list to the client 100 at step 214. Where the user of the client 100 selects a specific MR from the MR list sent from the server 102, the CGI application 104 of the server 102 performs an HTML conversion for a report of the selected MR, and sends the resulting MR report to the user of the client 100. If the user of the client 100 selects the error block part using a mouse to see the contents of errors generated during package creation, the client 100 sends an error contents output request message to the server 102 at step 216. In response to the error contents output request message sent from the client 100, the CGI application 104 of the server 102 searches the DB 108 for error contents, converts the searched error contents into HTML information, and sends the converted HTML information, to the user of the client 100, at step 218.

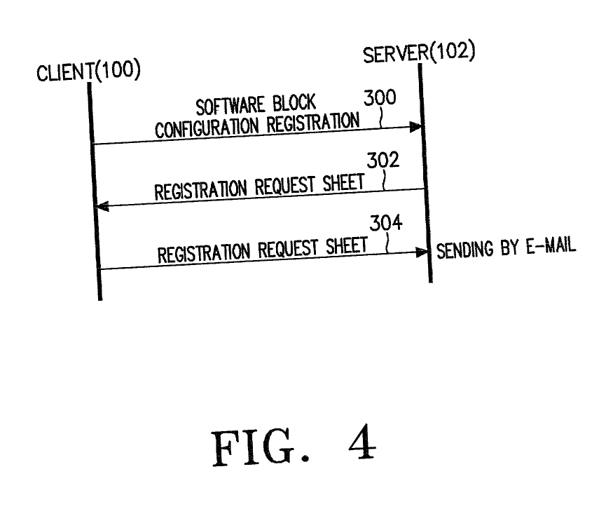

FIG. 4 is a flowchart illustrating the software block configuration registration process shown in FIG. 2, and includes steps 300 to 304 performed between the client 100 and the server 102. The software block configuration registration process is carried out to register software block configurations of an exchange system and similar systems. Where registration of a software block configuration is requested using this menu item, the server 102 sends registration request sheets to a loading software block manager, a software package creator and SABLIME DB manager, respectively, by electronic mail (E-mail). On the basis of the contents of the respective registration request sheets sent from the server 102, the loading software block manager enters associated information in a system loading data table, the SABLIME DB manager sets up a SABLIME environment and software component oriented process environment (SCOPE) to manage a source of the configuration registration-requested software block, and the package creator appends an execution module of the requested software block to the final software package. In more detail, if the user of the client 100 selects the software block configuration registration menu item, then the client 100 sends a software block configuration registration request message to the server 102 at step 300. In response to the registration request message sent from the client 100, the server 102 sends an HTML registration request sheet to the user of the client 100 at step 302. Subsequently, if the user fills out the registration request sheet sent from the server 102 with desired contents, then the client 100 sends the resulting registration request sheet back to the server 102 at step 304. The server 102 then transfers the registration request sheet from the client 100 to the CGI application 104 to verify the contents thereof. At this point, if no contents to be verified are present in the registration request sheet sent from the client 100, the server 102 requests the user to enter those contents again through the client 100. Where the contents of the HTML registration request sheet sent from the client 100 are verified as being valid, the server 102 sends those contents to the respective above-described managers and creator by E-mail, and appends them to the DB 108. On the other hand, where the requested software block is already present in the DB 108, the server 102 asks the user whether he or she desires to continue the process of that software block. If the user desires to continue the process of the requested software block, the server 102 updates the DB 108 and sends the updated contents by E-mail. If the user does not desire to continue the process of the requested software block, the server 102 requests the user to reenter desired contents through the client 100.

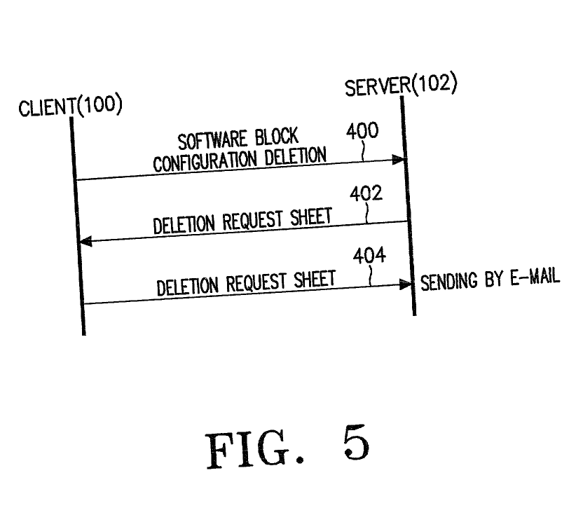

FIG. 5 is a flowchart illustrating the software block configuration deletion process shown in FIG. 2, and includes steps 400 to 404 performed between the client 100 and the server 102. The software block configuration deletion process is carried out to delete a software block no longer required in an exchange system from the DB 108 over the Web, and to send the deleted result to a loading software block manager, software package creator and SABLIME DB manager by E-mail so that the managers and creator perform their operations in a manner appropriate to the sent result. In more detail, if the user selects the software block configuration deletion menu item in the client 100, then the client 100 sends a software block configuration deletion request message to the server 102 at step 400. In response to the deletion request message sent from the client 100, the server 102 sends a simple HTML deletion request sheet to the client 100 at step 402. If the user of the client 100 fills out the simple deletion request sheet sent from the server 102 with desired contents, then the client 100 sends the resulting deletion request sheet back to the server 102 at step 404. The server 102 then verifies the contents of the deletion request sheet sent from the client 100. Where a software block to be deleted is not present in a software block configuration storage area of the DB 108, the server 102 sends a warning message to the client 100 to warn the user that configuration information of the software block to be deleted is not present in the DB 108, and then asks the user whether he or she desires to continue the process of that software block. If the user desires to continue the software block process, the server 102 sends a detailed HTML deletion request sheet to the client 100. The user of the client 100 fills out the detailed deletion request sheet sent from the server 102 with desired contents, and sends the resulting deletion request sheet back to the server 102. Thereafter, the server 102 determines whether the contents of the detailed deletion request sheet sent from the client 100 are valid. Upon determining that the contents of the sent deletion request sheet are not valid, the server 102 sends the detailed deletion request sheet again to the client 10. Where the contents of the sent deletion request sheet are determined to be valid, the server 102 deletes a software block configuration from the software block configuration storage area of the DB 108 on the basis of those contents, and then sends the resulting deletion request sheets to the above-described managers and creator, respectively, by E-mail.

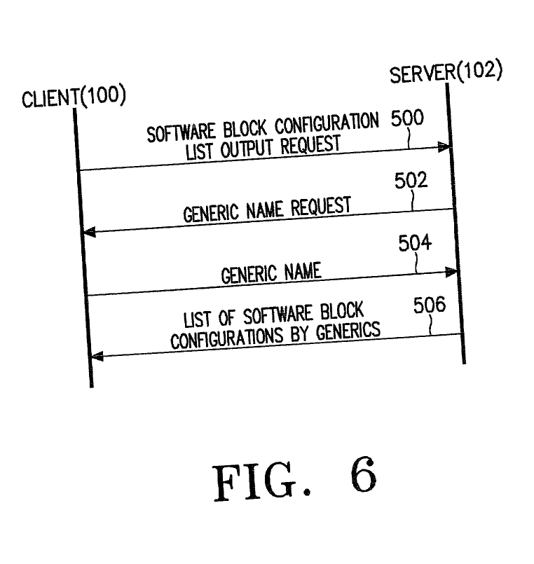

FIG. 6 is a flowchart illustrating the software block configuration list output process shown in FIG. 2, and includes steps 500 to 506 performed between the client 100 and the server 102. The software block configuration list output process is carried out to output a list of configurations of software blocks that the user has registered using the software block configuration registration function. In the present embodiment, the output list contains information about block names, subsystem names, execution module names, managers, processor types, processors, etc. by software blocks. In more detail, if the user selects the software block configuration list output menu item in the client 100, then the client 100 sends a software block configuration list output request message to the server 102 at step 500. In response to the list output request message sent from the client 100, the server 102 sends a generic name request HTML message to the client 100 at step 502. If the user of the client 100 enters a desired generic name in response to the generic name request message sent from the server 102, then the client 100 sends the entered generic name to the server 102 at step 504. At step 506, the server 102 inputs the generic name from the client 100, and runs the CGI application 104 to search the DB 108 for information associated with the inputted generic name. The server 102 then extracts the associated information from the DB 108, converts the extracted information into HTML information, and sends the converted HTML information to the client 100.

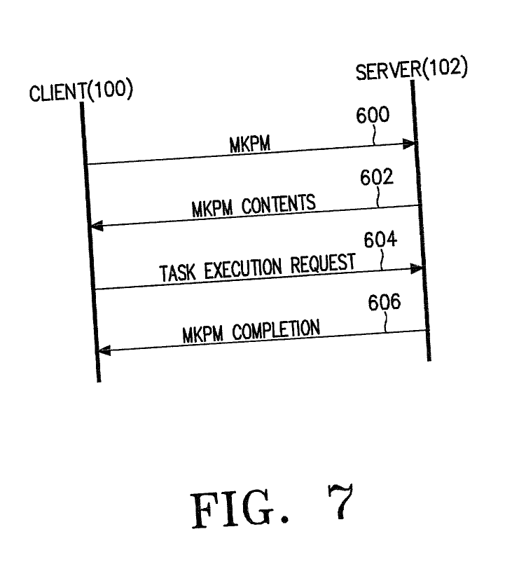

FIG. 7 is a flowchart illustrating the MKPM process shown in FIG. 2, and includes steps 600 to 606 performed between the client 100 and the server 102. The MKPM function is used for a test of MMSDATA or PLD by the user before creation of a software package in an exchange system. The UNIX X-terminal GUI (SWISS) is typically provided to perform the MKPM function. It is further noted that the MKPM function employs the JAVA applet to use the same menu as that of an algorithm previously provided on the Web. In more detail, if the user selects the MKPM menu item in the client 100, then the client 100 sends an MKPM request message to the server 102 at step 600. In response to the MKPM request message sent from the client 100, the server 102 runs the JAVA applet 106 to perform the MKPM process, and then sends the processed contents to the client 100, at step 602. Subsequently, using the JAVA applet displayed in the client 100, the user requests the server 102 to execute a desired MKPM task, at step 604. Upon receiving the MKPM task execution request from the user, the server 102 executes the requested MKPM task, stores the results of the execution in the test data storage unit 110, and sends an MKPM completion message to the client 100, at step 606. In the present embodiment, the JAVA applet includes menu items, such as component registration/deletion, IROF registration/deletion, PLD creation/deletion, MMSDATA creation/deletion, etc.

Accordingly, the user can create a software package on the Web in order to most readily use the same contents as those of functions provided with the UNIX X-terminal GUI (SWISS). The user can also directly use an existing DB and various information provided on UNIX as if he or she has received the same information from UNIX. The user can further rapidly develop and construct associated applications.

As is apparent from the above description, the present invention provides a system for supporting creation of a software package and a test therefor, wherein a user is provided with information associated with the software package creation from a server through a client using the Web, or the creation of test data by the user is supported by the server. Therefore, the present system is capable of improving efficiency and reliability of software package development and source version management, and the efficiency of software package creation, and of rapidly searching for information regarding software packages. Furthermore, the present system enables the user to employ a free Web browser without purchasing a costly emulator, thereby curtailing development costs.

While this invention has been described in connection with what is presently considered to be the most practical and preferred embodiment, it is to be understood that the invention is not limited to the disclosed embodiment, but, on the contrary, it is intended to cover various modifications within the spirit and scope of the appended claims. In particular, although the present system has been disclosed in the present embodiment to provide, as typical menu items, a package creation specifications output function, a software block configuration registration function, a software block configuration deletion function, a software block configuration list output function and an MKPM function for illustrative purposes, those skilled in the art will appreciate that it can provide all or some of other necessary functions associated with a software package in the same manner.

What is claimed is:

1. A system for providing information associated with creation of a software package, comprising:
a server including a database having software package creation associated information stored therein, and an application responsive to a client request for output of said software package creation associated information for gaining access to said database to extract said software package creation associated information therefrom, and for transmitting the extracted software package creation associated information; and
a client for receiving the transmitted software package creation associated information, and having a Web client tool set-up for accessing said server, said client being responsive to a software package creation associated information request from a user for downloading said software package creation associated information from said server over the Web, and for providing the downloaded software package creation associated information to the user.

2. The system as set forth in claim 1, wherein said application comprises a common gateway interface (CGI) application.

3. The system as set forth in claim 1, wherein said client comprises a personal computer.

4. The system as set forth in claim 3, wherein said software package comprises a software package for an exchange.

5. The system as set forth in claim 2, wherein said software package comprises a software package for an exchange.

6. The system as set forth in claim 1, wherein said software package comprises a software package for an exchange.

7. A system for providing information associated with creation of a software package, comprising:
a server including a database having an area for storing package creation specifications, a modification request (MR) list, and MR contents of the software package, and an application responsive to a client request for output of any one of said package creation specifications, said MR list and said MR contents for gaining access to said database to extract said any one of said package creation specifications, said MR list and said MR contents therefrom, and for transmitting said outputted any one of said extracted package creation specifications, said MR list and said MR contents; and
a client for receiving said transmitted any one of said extracted package creation specifications said MR list and said MR contents, and having a Web client tool set-up therein for accessing said server, said client being responsive to a request for any one of said package creation specifications, said MR list and said MR contents from a user for downloading said any one of said package creation specifications, said MR list and said MR contents from said server over the Web, and for providing said downloaded any one of said package creation specifications, said MR list and said MR contents to the user.

8. The system as set forth in claim 7, wherein said application comprises a CGI application.

9. The system as set forth in claim 7, wherein said client comprises a personal computer.

10. A system for providing informnation associated with creation of a software package, comprising:
a server including a database having an area for storing software block configurations of the software package, and an application responsive to a client request for output of a list of the software block configurations for gaining access to said database to extract said software block configurations therefrom, and for transmitting the extracted software block configurations;
a client for receiving the transmitted software block configurations, and having a Web client tool set-up for accessing said server, said client being responsive to a software block configuration list request from a user for downloading said software block configurations from said server over the Web, and for providing the downloaded software block configurations to the user.

11. The system as set forth in claim 10, wherein said application comprises a CGI application.

12. The system as set forth in claim 10, wherein said client comprises a personal computer.

13. A system for providing information associated with creation of a software package, comprising:
a server including a database having an area for storing at least one software block configuration of the software package, and an application for selectively registering said software block configuration in, and deleting said software block configurations from, said database when a client request is received by said server over the Web; and
a client having a Web client tool set-up therein for accessing said server, said client being responsive to a user request for selectively sending one of a software block configuration registration and a deletion request message to said server over the Web.

14. The system as set forth in claim 13, wherein said application comprises a CGI application.

15. The system as set forth in claim 13, wherein said client comprises a personal computer.

16. A system for supporting creation of test data for a test of a system employing a software package, comprising:
a server including a test data storage unit for storing information associated with the test data creation and the test data, and an application responsive to a client request for creating said test data for executing an associated task to create said test data, and for storing the created test data in said test data storage unit; and
a client having a Web client tool set-up therein for accessing said server, said client being responsive to a test data creation request from a user for sending a test data creation request message to said server over the Web.

17. The system as set forth in claim 16, wherein said application comprises a JAVA applet.

18. The system as set forth in claim 16, wherein said client comprises a personal computer.

19. The system as set forth in claim 18, wherein said test data includes at least one of processor loading data and man machine subsystem data.

20. The system as set forth in claim 19, wherein said software package comprises a software package for an exchange.

21. The system as set forth in claim 17, wherein said test data includes at least one of processor loading data and man machine subsystem data.

22. The system as set forth in claim 21, wherein said software package comprises a software package for an exchange.

23. The system as set forth in claim 16, wherein said test data includes at least one of processor loading data and man machine subsystem data.

24. The system as set forth in claim 23, wherein said software package comprises a software package for an exchange.
